(19) United States
(12) Patent Application Publication
(10) Pub. No.: US 2008/0028670 A1
(43) Pub. Date: Feb. 7, 2008

(54) SILICONE ADDITIVES FOR COMPATALIZING ORGANIC COMPOUNDS WITH WAX MIXTURES

(75) Inventors: Jo Anne Tully, Mahopac, NY (US); Suresh K. Rajaraman, Newburg, NY (US); Robert E. Ruckle, Brewster, NY (US)

Correspondence Address: MOMENTIVE PERFORMANCE MATERIALS INC.;IP LEGAL, ONE PLASTICS AVENUE, BLDG. 51, PITTSFIELD, MA, 01201-3697, US

(73) Assignee: General Electric Company, Schnectady, NY (US)

(21) Appl. No.: 11/461,920

(22) Filed: Aug. 2, 2006

(51) Int. Cl. C11C 5/00

(52) U.S. Cl. 44/275

(57) ABSTRACT

The present invention discloses the use of compatibilizing agent such as an organic or silicone in a wax mixture to increase compatibility (i.e. to increase dispersion and/or to prevent phase separation) of added organic compounds and dyes with the major components of the wax mixture, e.g. the candle fuel source. The compatibilizing agent whereby said compatibilizing agent does not extinguish combustion of the wax mixture when the wax mixture is burned.

### CROSS REFERENCE TO RELATED APPLICATION

This application claims the benefit of U.S. application Ser. No. 11/314,865 filed Dec. 20, 2005, and U.S. Provisional Application Ser. No. 60,258,894.

### FIELD OF INVENTION

The present invention deals with wax mixtures and compositions suitable for incorporating fragrances, flavors, flavonoids, biocides and colors (dyes). More particularly the present invention deals with compatibilizing agents that tend to stabilize or compatibilize the dispersion of organic additives and colored dyes in the wax mixture fuel material or that tend to prevent phase separation between the major and minor components of the wax mixture.

### BACKGROUND

The incorporation of organic compounds such as fragrant oil(s) (perfumes) in wax mixtures is difficult to achieve in quantities sufficient to ensure the release of a suitable level of fragrance into the atmosphere for the end use customer. Incorporating high loadings of fragrances, particularly smaller, highly volatile perfumes, tends to result in migration and volatilization of the fragrance compound(s) being added during the wax mixture making process. Migration of the fragrant compounds in the finished wax mixture leads to weeping or bleeding of the fragrant oils at the surface during storage as well as mottling of the surface. The candle making industry, therefore, has long searched for an effective technique of manufacture or an additive, that would prevent or inhibit the separation of liquid oil additives and allows for incorporation of greater amounts of organic compounds such as fragrance.

Several approaches to solving this problem have been disclosed. U.S. Pat. No. 6,775,6808 indicates the use of poly(alpha olefin) additives inhibit the separation of liquid oil additives from paraffin wax in paraffin objects such as candles. These materials primarily solve the problem of liquid additives such as liquid fragrances and liquid dyes separating or pooling in the top surfaces of candles after storage at room temperature.

U.S. Patent application 20030064336 discloses the use of a perfume-loaded porous inorganic carrier particles to produce intense and long-lasting fragrances. U.S. Patent application 20040068920 discloses a stabilized fragrance candle composition comprising wax, fragrance, and a stabilizing composition comprising an ultraviolet (UV) absorber and a hindered hydroxybenzoate.

### BRIEF SUMMARY

The present invention provides for a composition suitable for use in a wax mixture comprising:

a) a wax;

b) an organic compound; and

c) a compatibiltizing agent

whereby said compatibiltizing agent does not extinguish the wax mixture when it is burned. The present invention further provides for a method for preventing phase separation, reduced mottling, and increased cold and hot throw in a wax mixture comprising a wax and a fragrant, said method comprising:
a) admixing
   i) an organic compound and
   ii) a compatibilizing agent
      to form a mixture and
b) adding the mixture to a wax forming a candle precursor; and
c) making a candle using the wax mixture precursor.

Additionally the present invention provides for a method for preventing phase separation, reduced mottling, and increased cold and hot throw in a wax mixture comprising a wax and a fragrant, said method comprising:
a) admixing
   i. a compatibilizing agent
   ii. a wax mixture
      to form a wax mixture and
b) forming a candle precursor using the wax mixture and an organic compound; and
c) making a candle using the candle precursor.

### DETAILED DESCRIPTION

The present invention relates to the inclusion of an additive in a wax mixture for increased compatibility of an organic compound with the wax, a so-called compatibilizing agent. One embodiment of such an additive is a silicone composition. The benefit of increased organic compatibility with the base wax is delivered by blending between 0.01 to about 25 percent by weight of the organic compound with the wax mixture, more preferably between 0.1 and about 15 percent by weight. This mixture is incorporated into the wax mixture with simple agitation when the wax is heated to its melting temperature. The additives improve the compatibility of the organic compound with the wax. Such additives render the wax more uniform in appearance than wax mixtures not treated with an organic compound and these silicone additives. In addition wax mixtures treated with silicone additives with organic compounds in wax compositions yield a flame that is comparable in height relative to the control itself, despite the well-known ability of many silicone compounds to act as flame retardants, thus the additive does not extinguish the flame i.e. does not extinguish combustion or significantly diminish the flame height. For purposes of definition the phrase significantly diminish the flame height means a flame height that is at least 95% the flame height of a control, preferably at least 90% the flame height of a control, more preferably at least 75% the flame height of a control, and most preferably at least 60% the flame height of a control. As herein defined a control candle for purposes of flame height measurements is a composition identical to the candle composition containing the compatibilizing agent but without the compatibilizing agent present. The benefit of the present invention allows for the inclusion of higher levels of organic compounds to be included in the wax mixtures without extinguishing the flame than those wax compositions that do not contain these additives. An additional benefit of the present invention allows for the inclusion of lower levels of organic compounds to be included in the wax mixtures without extinguishing the flame while having the same cold and hot throw as those wax compositions that do not contain these additives at higher levels of organic compounds. Cold and hot throw assessments are conducted by removing a 0.5 g core sample of the wax mixture with a #2 cork borer, placing in a 20 ml head space vial, sealing with a septum cap and evaluating the head space by GC-MS under two different temperature conditions.

The additive is a compatabilizing agent that allows two or more materials to exist in close and permanent association with each other for an indefinite period together without separating. Without wishing to be bound by theory it is believed that present invention relates to a liquid-liquid phase interaction that imparts improved solid characteristics related to solid miscibility thereby forming a composite or wax mixture having enhanced features and benefits.

The present invention includes the addition of silicone additives with an oil that is normally liquid at room temperature (such as to provide both a fragrance and appearance effect) in a wax mixture composition. These silicone additives provide for better compatibility of the oil with wax, and at the same time produces a flame that is consistent in height and burn rate.

A common form of candle material is wax, which usually refers to a substance that is a plastic to brittle solid at ambient temperatures. Suitable waxes for forming the candle body include any known waxes, including but not limited to, paraffin wax, microcrystalline wax, beeswax, animal wax, vegetable wax, mineral wax, synthetic wax, and mixtures thereof. In addition to wax semi-solids (such as petrolatum), liquids, synthetic polymers and mixtures of synthetic polymers with one or more organic compounds may be used in a candle material or part of a candle material. Other typically used candle fuel source components such as hydrocarbon oil, stearic acid, may also be included in the candle material. The nature of the paraffin wax is not critical to the practice of this invention and may be any of the numerous commercial paraffin waxes available. While the invention has been exemplified with paraffin wax, it is expected that the method of this invention would find utility in compatabilizing organic compounds with objects made with other waxes previously mentioned but not necessarily limited to.

While the term wax may be considered to be an imprecisely defined term it is generally understood to be an organic substance with properties that include 1) being a plastic or malleable solid at ambient temperatures with 2) a melting point approximately above 45° C. and with 3) a low viscosity when melted. As used herein the term wax includes any of various natural, oily or greasy heat-sensitive substances, consisting of hydrocarbons or esters of fatty acids that are insoluble in water but soluble in nonpolar organic solvents such as ether, benzene and certain esters. Some waxes may originate from petroleum and be found in rock layers, or be natural and secreted by bees or derived from the leaves of a plant or artificial.

As a subset of waxes, paraffin wax is a common name for a group of high molecular weight alkane hydrocarbons with the general formula CₙH₂ₙ₊₂ where n is greater than about 20. It is mostly found as a white, odorless, tasteless solid with a typical melting point between about 47° C. and 65° C. Paraffin waxes are generally unaffected by most ordinary chemicals and burns readily.

Paraffin wax is considered as a petrolatum wax. Paraffin wax is typically macrocrystalline and brittle. The solidified wax composition, at a microscopic level, includes wax crystals packed against each other. Components of a wax composition, such as colorant, are typically trapped in the spaces between wax crystals. Fragrant molecules, however, are typically too small to be held in these inter crystal spaces. Consequently, the fragrant molecules often diffuse through the wax mixture. This diffusion eventually brings the fragrance molecules to the surface, leading to weeping. The problem of weeping can be brought under control by the addition of chemicals that reduce the crystal size in the solidified wax mixture. The smaller crystals pack tightly enough to trap the odorant inside their inter-crystal spaces. Wax mixtures are evaluated for bleed or syneresis by wrapping them in preweighed absorbent tissue and placing them in sealed plastic bags and subjecting them to accelerated aging via temperature cycling over a 24 hr. period. The tissue is reweighed and the weight gain in considered to be a result of migrating fragrance.

With respect to the organic compound, the invention is especially suited for use with fragrant oils, flavors, flavonoids, and biocides and the like that are typically added to wax mixtures, where fragrant oils, flavors, flavonoids, and biocides and the like is typically liquid at room temperature. Solid examples of fragrant oils, flavors, flavonoids, and biocides and the like especially fragrant compounds can also be solubilized by the compatibilizing agents used in the present invention. These liquid oils include, but are not necessarily limited to, essential oils, fragrances, flavors, flavonoids, biocides and mineral oils. For example, cinnamon, vanillin, limonene, eugenol, spice, bayberry, pine fragrances, etc., are used as additives. More specifically the fragrant compounds may be selected from the group consisting of anethole, cinnamaldehyde, eugenol, benzyl benzoate, benzyl benzoate, benzyl salicylate, diphenyl oxide, benzyl acetate, α-amyl cinnamaldehyde, α-hexyl cinnamaldehyde, heliotropin, cyclamen aldehyde, p-t-butyl-α-methyl dihydrocinnamaldehyde, raspberry ketone, 2-phenylethyl alcohol and esters thereof, benzaldehyde, Coumarin, Isoamyl salicylate, Ethyl vanillin, Vanillin, methyl salicylate, moskene, isochroman musk, msk xylol, musk tibetine, musk ambrette, musk ketone, muscone, 5-acetyl-1,1,2,3,3,6-hexamethylindan, 5-acetyl-1,1,2,6-tetramethyl-3-isopropylindan, tetralin musk, civetone, cyclopentadecanolide, cyclopentadecanone, indan musk 4-acetyl-1,1-dimethyl-6-t-butyl-indan, thylene brassylate, fixateur 404, benzyl alcohol, vernaldehyde, leaf alcohol, maltol, ethyl maltol, verdyl acetate, jasmone, isojasmone, dihydrojasmone, Sandela, Vernetex, 4-(4-hydroxy-4-methylpentyl)-3-cyclohexene-10-carboxaldehyde, aliphatic aldehydes, fatty esters, Indoles, pyrazines, thiazoles, α-terpinol and esters thereof, citronellal and esters thereof, citronellol and esters thereof, linalool and esters thereof, citral, neral, hydroxycitronellal, geraniol and esters thereof, nerol and esters thereof, tetrahydrogeraniol, dimethyl octanol, ionones, borneol, borneol acetate, isoborneol, isoborneol acetate, acetylated cedarwood, 1-carvone, and 1-menthol.

In one non-limiting embodiment of the invention, the liquid fragrance oils are used in a total amount, based upon the total weight of the object, in proportions ranging from about 0 to about 50 wt %, preferably from about 0.5 to about 40 wt %, more preferably from about 1 to about 30 wt %, and most preferably from about 2 to about 20 wt %. Additionally, silicone materials that release a fragrant molecule by reaction, e.g. hydrolysis, may also be incorporated into the candle to provide fragrance. Examples of such fragrant silicon-containing molecules are to be found in U.S. Pat. Nos. 6,046,156; 6,075,111; 6,077,923; 6,083,901; 6,153,578; and 6,322,777.

Preferred silicone compatibilizing agents for use in the present invention include pendant polyalkylene oxide-modified polydialkylsiloxane having the formula: [ICP1]

MₐM_{b}M_{c}DₓD_{y}D_{z}T_{d}TₑT_{f}Q_{g};

where

Mₐ=R¹R²R³SiO_{1/2};[ICP2]

M_{b}=R⁴R⁵R⁶SiO_{1/2};[ICP3]

M_{c}=R⁷R⁸R⁹SiO_{1/2};[ICP4]

Dₓ=R¹⁰R¹¹SiO_{2/2}; [ICP5]

D_{y}=R¹²R¹³SiO_{2/2};[ICP6]

D_{z}=R¹⁴R¹⁵SiO_{2/2}[ICP7]

T_{d}=R¹⁶SiO_{3/2};[ICP8]

Tₑ=R¹⁷SiO_{3/2};[ICP9]

T_{f}=R¹⁸SiO_{3/2};[ICP10]

Q_{g}=SiO_{4/2}

where R¹, R², R³, R⁵, R⁶, R⁸, R⁹, R¹⁰, R¹¹, R¹³, R¹⁵ and R¹⁶ are each independently selected from the group consisting of one to sixty carbon monovalent hydrocarbon radicals, alkyl aryl radicals, aryl radicals, alkyl phenol radicals;

R⁴, R⁷, R¹², R¹⁴, R¹⁷ and R¹⁸ are each independently selected from the group radicals defined by the formula for Z;[ICP11] [ICP12]

where the subscripts a, b, c, x, y, z, d, e, f, and g are zero or positive integers for molecules subject to the following relationships:

(a+b+c) equals either (2+d+e+f+2g) or (d+e+f+2g)[ICP13]

0≦(x+y+z)≦100;

0≦(d+e+f)≦5;

0<g<3

with the requirement that b+y+e≧1;
and c+z+f>3, with Z having the formula:

BO(C₂H₄O)ₙ(C₃H₆O)ₚ(C₄H₈O)ᵣR¹⁸

where B is an alkylene radical of 2 to 4 carbons

R¹⁸ is a H, or a hydrocarbon radical of 1 to 4 carbons.

n, p and r are independently zero or positive subject to the requirement that:

4≦n+p+r≦100.

Another suitable group of silicone additives can be selected from the class of ABₙ copolymers formed by the hydrosilation of hydride terminated polydimethylsiloxane and an olefinically modified polyalkyleneoxide, such as allyl or methallyl terminated polyalkyleneoxides. Additives of this type follow the general structure:

(A¹B¹)ₜ

where A¹ has the general structure:

—Si(R¹⁹)(R²⁰)O—(Si(R²¹)(R²²)O—)ₓ—Si(R²³)(R²⁴)—

and B¹ has the general structure:

—R²⁵OR²⁶R²⁷—

where R¹⁹, R²⁰, R²¹, R²², R²³ and R²⁴ are independently selected from a monovalent hydrocarbon radical of 1 to 4 carbons; t is 2 to 20; x is 0 to 50; R²⁵ and R²⁷are independently selected from a divalent hydrocarbon radical of 2 to 10 carbons or Y¹; Y¹ is a monovalent hydrocarbon radical of 1 to 6 carbons, each optionally OH substituted, or R²⁸, where R²⁸ is CH₂═CH(R²⁹)(R³⁰)_{g}—; R²⁹ is H or methyl; R³⁰ is selected from a divalent hydrocarbon radical of 1 to 7 carbons; g is 0 or 1, and the subscript t ranges from about 2 to about 1000; specifically from about 3 to about 800; more specifically from about 5 to 600; and most specifically from about 5 to 500. It is noted that the foregoing structure for (A¹B¹)ₜ is empirical and thus subtends geometric and structural and isomers, e.g. block and random copolymers.

R²⁶ is selected from a group of polyalkyleneoxide radicals of the following structure:

—(C₂H₄O)_{d}(C₃H₆O)ₑ(C₄H₈O)_{f}—, where subscripts d+e+f are zero or positive and satisfy the following relationships: 2≦d+e+f≦100.

The polyalkyleneoxide radical may also be blocked or random.

Additional suitable silicone additives may be selected from the class of amino modified Non-(AB)n and random block structures formed by the ring opening of an epoxide, with an amine-connecting group. Silicone additives of this nature are represented by

(A²B²C¹)ₘ

where A² has the general structure:

—(R³¹—Si(R³⁵)(R³⁶)O—(Si(R³⁷)(R³⁸)O)ᵥ—Si(R³⁹)(R⁴⁰)—R³²)—

B² is an amine-connecting group with the general formula:

—N(R⁴¹)(R⁵⁴)_{Ψ}—

C¹ is a polyalkyleneoxide moiety of the general structure:

—R⁴²—O—R⁴³—R⁴⁴—

Where R³⁵, R³⁶, R³⁷, R³⁸, R³⁹ and R⁴⁰ are independently selected from a monovalent hydrocarbon radical of 1 to 4 carbons; m is 2 to 1000; v is 0 to 50; R³¹ and R³² are independently selected from a divalent hydrocarbon radical of 2 to 10 carbons, which are optionally OH substituted, or R³³; R³³ is an epoxy group of the general formula:

—R⁵⁰(O)_{L}(R⁵¹)_{I}R⁵²

where R⁵⁰ and R⁵¹ are independently selected from a divalent hydrocarbon radical of 1 to 10 carbons; R⁵² is —CH(O)CH₂, or a cyclohexeneoxide of the formula —C₆(R⁵³)ᵤH₉₋ᵤO; R⁵³ is a monovalent hydrocarbon group of 1 to 2 carbon atoms; R⁵⁴ is hydrogen, a monovalent hydrocarbon radical of 1 to 4 carbons, and a hydrocarbon radical containing an OH group; subscripts L and I are 0 or 1; u is 0 to 2; Ψ is 0 or 1 and the subscript m ranges from about 2 to about 1000; specifically from about 3 to about 800; more specifically from about 5 to 600; and most specifically from about 5 to 500. It is noted that the foregoing structure for (A²B²C¹)ₘ is empirical and thus subtends geometric and structural and isomers, e.g. block and random copolymers.

R⁴² and R⁴⁴ are independently selected from a divalent hydrocarbon radical of 2 to 10 carbons, which are optionally OH substituted, or R⁴⁵; R⁴³ is selected from a group of polyalkyleneoxide radicals of the following structure:

—(C₂H₄O)ₕ(C₃H₆O)ⱼ(C₄H₈O)ₖ—, where subscripts h+j+k are zero or positive and satisfy the following relationships: 2≦h+j+k≦100.

The polyalkyleneoxide radical may also be blocked or random.

R⁴⁵ is an epoxy group of the general formula:

—R⁴⁶(O)_{q}(R₄₇)_{w}R⁴⁸

where R⁴⁶ and R⁴⁷ are independently selected from a divalent hydrocarbon radical of 2 to 10 carbons; R⁴⁸ is —CH(O)CH₂, or a cyclohexeneoxide of the formula —C₆(R⁴⁹)ₛH_{g-s}O.

R⁴⁹ is a monovalent hydrocarbon group of 1 to 2 carbon atoms. Subscripts q and w are 0 or 1; s is 0 to 2.

The arrangement of A², B² and C¹ may be blocked or random.

The silicone copolymers employed in the practice of the present invention can be prepared by general methods that are well know to those skilled in the art. For example, U.S. Pat. Nos. 3,280,160; 3,299,112; and 3,507,815 report the synthesis of copolymers of this type and demonstrate their utility as polyurethane foam stabilizers, as additives for personal care items, and as processing aids for textile applications. The copolymers can be prepared from allyl polyethers and polydimethylhydrosiloxanes and in the presence (U.S. Pat. Nos. 3,980,688 and 4,025,456) or absence (U.S. Pat. Nos. 4,847,398 and 5,191,103) of a solvent.

The wax mixtures of the current invention employ a wick, placed in the portion of the candle material comprising the organic compound and silicone additive dispersed throughout. The wick should be sufficiently thick so that it is not so small as to drown in a pool of molten wax as the wax mixture burns, but not so excessively thick so as to cause the wax mixture to smoke, drip excessively, and/or burn quickly. Typically, wicks are made of braided cotton in many different diameters, ranging from about 0.375 inches to about 3.75 inches.

All US patents referenced herein are specifically herewith incorporated by reference.

### EXAMPLE 1

84.5 g of Wax 1 was melted in a double boiler/water bath. 15 g of fragrance 1 and 0.5 g of the silicone or additive of Table 1 was blended together in a conventional manner. This mixture was then added to the molten wax until homogenous, and prior to being poured into a glass mold fitted with a wick near the center of the mold to form a wax mixture. The wax mixture was allowed to cool under ambient conditions.

The wax mixtures were tested for appearance and burn time. Burn time is the time it takes for the flame to consistently burn with a reduced height when compared to the control where the only difference is the absence of the silicone additive. Appearance includes all aspects of the wax mixture to include uniformity of color, weeping, mottling, and craters. The scores are assigned based on visual observations and rated on a relative scale of 1 to 5 (5 is most desirable).

TABLE 1

| | |
|---|---|
| Silicone A | Linear ethylene oxide modified polydimethylsiloxane |
| Silicone B | First pendant ethylene oxide, propylene oxide modified |
| | polydimethylsiloxane |
| Silicone C | Second pendant ethylene oxide, propylene oxide modified |
| | Polydimethylsiloxane |
| Silicone D | First pendant propylene oxide modified |
| | polydimethylsiloxane |
| Silicone E | First pendant ethylene oxide modified polydimethylsiloxane |
| Silicone F | First alkyl modified polydimethylsiloxane |
| Silicone G | Aryl modified polydimethylsiloxane |
| Silicone H | Second alkyl modified polydimethylsiloxane |
| Silicone I | Second pendant propylene oxide modified |
| | polydimethylsiloxane |
| Silicone J | Linear propylene oxide modified polydimethylsiloxane |
| Silicone K | Third pendant propylene oxide modified |
| | polydimethylsiloxane |
| Silicone L | Fourth pendant propylene oxide modified |
| | polydimethylsiloxane Insert Silicone L after silicone K in |
| | table |
| Silicone M | First linear amino polyalkyleneoxide modified |
| | polydimethylsiloxane |
| Additive A | First polypropylene glycol |
| Additive B | Second propylene glycol |
| Additive C | Third propylene glycol |
| Additive D | First nonylphenol ethoxylate |

TABLE 2

| EXAMPLE | APPEARANCE | BURN TIME |
|---|---|---|
| Wax 1 | 4.5 | 5+ |
| Wax 1/Fragrance 1 | 1 | 4.5 |
| Wax 1/Fragrance 1/Silicone A | 1 | 2 |
| Wax 1/Fragrance 1/Silicone B | 1 | 2 |
| Wax 1/Fragrance 1/Silicone C | 1 | 2+ |
| Wax 1/Fragrance 1/Silicone D | 4 | 5+ |
| Wax 1/Fragrance 1/Silicone E | 2.5 | 2 |
| Wax 1/Fragrance 1/Silicone F | 4 | 1 |
| Wax 1/Fragrance 1/Silicone G | 2 | 1 |
| Wax 1/Fragrance 1/Silicone H | 2 | 1.5 |
| Wax 1/Fragrance 1/Silicone I | 3.5 | 4.5 |
| Wax 1/Fragrance 1/Silicone J | 1.5 | 4.5 |
| Wax 1/Fragrance 1/Silicone K | 4 | 3.5 |
| Wax 1/Fragrance 1/Silicone L | 4 | 4+ |
| Wax 1/Fragrance 1/Additive A | 3 | 4 |
| Wax 1/Fragrance 1/Additive B | 3 | 4.5 |
| Wax 1/Fragrance 1/Additive C | 3 | 4+ |
| Wax 2/Fragrance 7 | 3 | 5 |
| Wax 2/Fragrance 7/Silicone M | 4 | 3 |
| Wax 2/Fragrance 7/Additive D | 3.5 | 5 |

The above examples reveal that fragranced wax mixtures fashioned with compositions according to this invention in particular pendant propylene oxide modified polydimethylsiloxane are improved with respect to appearance and compatabilization of the fragrance than those of other conventional compositions that do not contain such additives. Different silicone additives from those discussed and exemplified are also expected to be useful in the inventive method and products depending upon the exact combinations of liquid oils and organo-modified polydimethylsiloxane

It will be appreciated that it is difficult to specify with accuracy in advance the proportion of silicone additive to be used in a particular paraffin wax formulation to enhance oil compatibility without adversely effecting flame height. The best way to determine this proportion is by experimentation. The proportion of silicone additive in a particular paraffin wax formulation will depend upon a number of complex, interrelated factors including, but not necessarily limited to, the nature of the paraffin wax, the proportion and nature of the liquid oil additive, the nature of the silicone additive, but not necessarily limited to, the initial melt temperature and the rate of cooling, among other factors. Nevertheless, in an effort to give some indication of typical silicone additive concentration, in non-limiting embodiments the amount may range from about 0.1 wt % to 10 wt %, based on the total object weight, preferably from about 0.25 wt % to about 5 wt %.

### Waxes

Below is a table of the types of waxes used in the candle industry. Usage level is up to 99% in fragranced candles and rarely less than 80-85%. Sometimes these are mixed to control the T_{g} of the candle which influences hardness, burn rate, melt pool temperature (and hence fragrance throw off), and other properties.

TABLE 3

| Wax Type | Market Share |
|---|---|
| Paraffin | 70% |
| Beeswax | 15% |
| Candlelilla | 6% |
| Soy | 5% |
| Fischer-Tropsch | 3% |
| Microcrystalline wax | 1% |
| Tallow (not used) | 0% |

| WAXES: | |
|---|---|
| Wax 1 | General Purpose Paraffin Wax |
| Wax 2 | 140° F. Melt Paraffin Wax from Exxon Mobil |

### Fragrances

There are a myriad of molecules used as fragrances. These are typically blended and/or diluted with non-odiferous materials by the fragrance houses. Most are naturally occurring and isolated, only a few are synthesized. The fragrance is typically the highest unit/per costing product in the candle.

Use levels are up to 15%, as received, in highly fragranced premium candles. More commonly 5% is used in mass market candles to lower cost. The low end is probably 4%.

Below is a table of the fragrant chemicals used.

TABLE 4

| Fragrance | Chemical Name | Family |
|---|---|---|
| Musk tibetine | 2,6-dinitro-3,4,5-trimethyl-t-butyl benzene | Musk |
| Musk ambrette | 2,6-dinitro-3-methoxy-4-t-butyl toluene | Musk |
| Musk ketone | 3,5-dinitro-2,6-dimethyl-4-t-butyl-acetophenone | Musk |
| Muscone | 3-methyl-cyclopentadecanone-1 | Musk |
| 5-acetyl-1,1,2,3,3,6- | 5-acetyl-1,1,2,3,3,6-hexamethylindan | Musk |
| hexamethylindan | | |
| 5-acetyl-1,1,2,6- | 5-acetyl-1,1,2,6-tetramethyl-3-isopropylindan | Musk |
| tetramethyl-3- | | |
| isopropylindan | | |
| Tetralin musk | 7-acetyl-1,1,3,4,4,6-hexamethyl-1,2,3,4-tetrahydro | Musk |
| | napthalene | |
| Civetone | Cycloheptadecen-9-one | Musk |
| Cyclopentadecanolide | Cyclopentadecanolide | Musk |
| Cyclopentadecanone | Cyclopentadecanone | Musk |
| Indan musk 4-acetyl- | Indan musk 4-acetyl-1,1-dimethyl-6-t-butyl-indan | Musk |
| 1,1-dimethyl-6-t-butyl- | | |
| indan | | |
| Thylene brassylate | Thylene brassylate | Musk |
| Fixateur 404 | Fixateur 404 | Other |
| Benzyl Alcohol | Benzyl Alcohol | Other |
| Vernaldehyde | Vernaldehyde | Other |
| Leaf alcohol | cis-3-hexene-1-ol | Other |
| Maltol (& ethyl maltol) | 3-hydroxy-2-methyl-γ-pyrone | Other |
| Verdyl acetate | Verdyl acetate | Other |
| Jasmone, isojasmone & | Jasmone, isojasmone & dihydrojasmone | Other |
| dihydrojasmone | | |
| Sandela | Sandela | Other |
| Vernetex | p-t-butyl-cyclohexyl acetate | Other |
| 4-(4-hydroxy-4- | 4-(4-hydroxy-4-methylpentyl)-3-cyclohexene-10- | Other |
| methylpentyl)-3- | carboxaldehyde | |
| cyclohexene-10- | | |
| carboxaldehyde | | |
| Aliphatic aldehydes | Aliphatic aldehydes | Other |
| Fatty esters | Fatty esters | Other |
| Indoles, pyrazines, | Indoles, pyrazines, thiazoles | Other |
| thiazoles | | |
| α-terpinol (& esters) | α-terpinol (& esters) | Terpenoid |
| Citronellal | Citronellal | Terpenoid |
| Citronellol (& esters) | Citronellol (& esters) | Terpenoid |
| Linalool (& esters) | Linalool (& esters) | Terpenoid |
| Citral or neral | Citral or neral | Terpenoid |
| Hydroxycitronellal | Hydroxycitronellal | Terpenoid |
| Geraniol or nerol (& | Geraniol or nerol (& esters) | Terpenoid |
| esters) | | |
| Tetrahydrogeraniol | Tetrahydrogeraniol | Terpenoid |
| Dimethyl Octanol | 3,6-dimethyloctan-3-ol | Terpenoid |
| Ionones | Ionones | Terpenoid |
| Borneol/isoborneol (& | Borneol/isoborneol (& acetates) | Terpenoid |
| acetates) | | |
| Acetylated cedarwood | Cedryl acetate | Terpenoid |
| 1-Carvone | 1-Carvone | Terpenoid |
| 1-Menthol | 1-Menthol | Terpenoid |

### Finished Fragrances:

Fragrance 1 Yaley Enterprises French Vanilla
Fragrance 2 Blood Valencia from Givaudan
Fragrance 3 Berry I from Manheimer, Inc
Fragrance 4 Tropical Berry from International Flavors and Fragrances, Inc
Fragrance 5 Cinnamon from International Fragrance and Technology, Inc.
Fragrance 6 Carmel Apple from BMC Manufacturing, LLC
Fragrance 7 Vanilla Fragrance from Manheimer, Inc

### Additives.

Stearic acid is typically used, at levels up to 5%. The purpose is to harden the wax and to improve the appearance of the candle.

Vybor, from Baker Petrolite, is used at up to 1% to harden the wax.

BHT, Hindered amine light stabilizers and similar antioxidants are used at use levels sub 1%. Dyes are used at an unknown usage level.

MD_{7.0}D″_{3.0}M silicone additive where D″ is Me(SiO_{2/2})(CH₂)₃O(C₃H₆O)₁₂n-C₄H₉ is effective at 0.5 wit. % with vanilla. EO, PO and EO/PO silicone polyether copolymers and alkyl, aryl, and aminoalkyl derivatives as well as polyester derivatives also work with fragrances.

### EXAMPLE 2

Candle fragrances are a mixture of natural and synthetic materials which when incorporated into a candle can alter its appearance. This change in appearance can manifest itself as a change in color when compared to pure paraffin wax.

Additional wax mixtures were prepared in the manner previously set forth and once cooled were measured and horizontally cut into three sections. Each wax mixture section (top, middle, and bottom) were further broken up into smaller pieces, and a representative 5 gram sample from each section was placed in separate aluminum weighing dishes that measured 6 cm. in diameter. The aluminum dishes containing the wax mixture sections were placed in an oven, melted, cooled, and the resultant wax disk was measured for difference in color (Delta E) using the Hunter Lab Coloriquest and paraffin wax as the control. Lower Delta E means less change in color.

It is evident that the color, and therefore the fragrance of the wax mixture containing the silicone additive is more uniform and evenly dispersed across all 3 cross sections.

COLOR DIFFERENCE MEASURMENTS (DELTA E)
IN PARAFFIN SYSTEM SECTIONS

| | Fragrance 1 | Fragrance 1/Silicone Additive |
|---|---|---|
| top | 1.9 | 0.92 |
| middle | 1.51 | 0.95 |
| bottom | 0.89 | 1.04 |

### EXAMPLE 3

Syneresis (bleed) in wax mixtures is caused by incompatibility of additives such as fragrance with the base wax of a wax mixture. Wax mixtures were again prepared in the manner previously detailed and evaluated for candle bleed by wrapping them in preweighed absorbent tissue paper and subjecting them to accelerated aging via temperature cycling over a 24 hr. period. The tissue was reweighed and the weight gain is considered to be a result of migrating fragrance.

Results from this experiment indicate that the wax mixture containing the silicone additive exhibit less bleed.

SYNERESIS IN CANDLES
SUBSTRATE WEIGHT GAIN IN GRAMS

| | |
|---|---|
| Fragrance 1 | 1.15 g |
| Fragrance 1/Silicone Additive | 0.84 g |

### EXAMPLE 4

89.5 g of wax 2 was melted in a double boiler/water bath. 10 g of fragrance 2 and 0.5 g of a particular pendant ethylene oxide modified polydimethylsiloxane additive was blended together in a conventional manner. This mixture was then added to the molten wax until homogenous, and prior to being poured into a glass mold fitted with a wick near the center of the mold to form a wax mixture. Separately 10 g of fragrance 2 was added to molten paraffin wax, and prior to being poured into a glass mold fitted with a wick near the center of the mold to form another wax mixture. Separately 100 g of wax 2 was melted in a double boiler/water bath, and prior to being poured into a glass fitted with a wick near the center of the mold to form a wax mixture. The wax mixtures were allowed to cool under ambient conditions.

The wax mixtures were tested for combustion by placing them in a test area with minimal drafts, and under ambient conditions (68-86° F.) and measuring flame height, burn pool diameter at 1 hour intervals, and rate of consumption after 4 hours. Flame height is the height of the flame from the base of the flame at the wax pool surface to the highest visible point of the flame. Burn pool diameter is measured at the same time as flame height, and is the liquid surrounding the flame. Rate of consumption is the amount of wax consumed over a fixed period of time, and is calculated by weighing the initial mass of a given wax mixture, burning the wax mixture, re-weighing the remaining mixture and dividing the difference in mass by the precise burn time. The example reveals that the flame heights for both wax mixtures that contain fragrance are lessened relative to the wax only control, but there is no effect from

| | 1 hr. | 2 hr. | 3 hr. | 4 hr. |
|---|---|---|---|---|
| Wax 2 | 2.4 ± 0.2 | 3 ± 0.5 | 3.7 ± 0.3 | 4.2 ± 0.1 |
| Fragrance 2 | 0.9 ± 0.4 | 1.1 ± 0.6 | 1.3 ± 0.4 | 1.5 ± 0.4 |
| Fragrance 2/ | 0.9 ± 0.3 | 1.2 ± 0.3 | 1.5 ± 0.4 | 1.4 ± 0.3 |
| Silicone Additive | | | | |
| BURN POOL | | | | |
| DIAMETER: | | | | |
| Wax 2 | 4.7 ± 0.4 | 5.1 ± 0.3 | 5.6 ± 0.2 | 5.8 ± 0.2 |
| Fragrance 2 | 4.7 ± 0.6 | 4.8 ± 0.4 | 5 ± 0.5 | 5.2 ± 0.4 |
| Fragrance 2/ | 5 ± 0.6 | 5.1 ± 0.6 | 5.2 ± 0.4 | 5.4 ± 0.4 |
| Silicone Additive | | | | |
| RATE OF | | | | |
| CONSUMPTION: | | | | |
| Wax 2 | 5.17 ± 0.4 | | | |
| Fragrance 2 | 2.67 ± 0.9 | | | |
| Fragrance 2/ | 2.68 ± 0.6 | | | |
| Silicone Additive | | | | |

the silicone additive. A similar effect is seen for the rate of consumption.

### EXAMPLE 5

87.5 g of wax 2 was melted in a double boiler/water bath. 12 g of fragrance 3 and 0.5 g of a particular linear propylene oxide modified polydimethylsiloxane additive was blended together in a conventional manner. This mixture was then added to the molten wax until homogenous, and prior to being poured into a glass mold fitted with a wick near the center of the mold to form a wax mixture. Separately 12 g of fragrance 3 was added to molten wax 2, and prior to being poured into a glass mold fitted with a wick near the center of the mold to form another wax mixture. Separately 100 g of wax 2 was melted in a double boiler/water bath, and prior to being poured into a glass fitted with a wick near the center of the mold to form a wax mixture. The wax mixtures were allowed to cool under ambient conditions.

The wax mixtures were tested for combustion in the manner detailed in Example 4. The example reveals that the flame height, burn pool diameter, and rate of consumption are the same for all 3 wax mixtures tested and

| | 1 hr. | 2 hr. | 3 hr. | 4 hr. |
|---|---|---|---|---|
| FLAME HEIGHT: | | | | |
| Wax 2 | 2.3 ± 0.2 | 2.9 ± 0.4 | 3.7 ± 0.4 | 4.1 ± 0.2 |
| Fragrance 3 | 2.4 ± 0.4 | 2.7 ± 0.5 | 3.3 ± 0.6 | 3.8 ± 0.7 |
| Fragrance 3/ | 1.9 ± 0.4 | 2.1 ± 0.8 | 3.5 ± 0.4 | 2.8 ± 1.5 |
| Silicone Additive | | | | |
| BURN POOL | | | | |
| DIAMETER: | | | | |
| Wax 2 | 4.6 ± 0.4 | 5 ± 0.3 | 5.5 ± 0.2 | 5.8 ± 0.2 |
| Fragrance 3 | 5.6 ± 0.3 | 5.8 ± 0.2 | 5.9 ± 0.1 | 5.9 ± 0.1 |
| Fragrance 3/ | 5.8 ± 0.2 | 5.7 ± 0.2 | 5.8 ± 0.2 | 5.8 ± 0.4 |
| Silicone Additive | | | | |
| RATE OF | | | | |
| CONSUMPTION: | | | | |
| Wax 2 | 4.98 ± 0.43 | | | |
| Fragrance 3 | 4.44 ± 0.61 | | | |
| Fragrance 3/ | 5.09 ± 0.52 | | | |
| Silicone Additive | | | | |

that the silicone additive did not affect combustion.

### EXAMPLE 6

87.5 g of wax 2 was melted in a double boiler/water bath. 12 g of fragrance 3 and 0.5 g of a particular pendant ethylene oxide modified polydimethylsiloxane additive was blended together in a conventional manner. This mixture was then added to the molten wax until homogenous, and prior to being poured into a glass mold fitted with a wick near the center of the mold to form a wax mixture. Separately 12 g of fragrance 3 was added to molten wax 2, and prior to being poured into a glass mold fitted with a wick near the center of the mold to form another wax mixture. Separately 100 g of wax 2 was melted in a double boiler/water bath, and prior to being poured into a glass fitted with a wick near the center of the mold to form a wax mixture. The wax mixtures were allowed to cool under ambient conditions.

The wax mixtures were tested for combustion in the manner detailed in Example 4. The example reveals that the flame height, burn pool diameter, and rate of consumption are the same for all 3 wax mixtures tested and that the silicone additive did not affect combustion.

| | 1 hr. | 2 hr. | 3 hr. | 4 hr. |
|---|---|---|---|---|
| FLAME HEIGHT: | | | | |
| Wax 2 | 2.3 ± 0.2 | 2.9 ± 0.4 | 3.7 ± 0.4 | 4.1 ± 0.2 |
| Fragrance 3 | 2.4 ± 0.4 | 2.7 ± 0.5 | 3.3 ± 0.6 | 3.8 ± 0.7 |
| Fragrance 3/ | 2.6 ± 0.5 | 3.6 ± 0.5 | 4 ± 0 | 3.9 ± 0.3 |
| Silicone Additive | | | | |
| BURN POOL | | | | |
| DIAMETER: | | | | |
| Wax 2 | 4.6 ± 0.4 | 5 ± 0.3 | 5.5 ± 0.2 | 5.8 ± 0.2 |
| Fragrance 3 | 5.6 ± 0.3 | 5.8 ± 0.2 | 5.9 ± 0.1 | 5.9 ± 0.1 |
| Fragrance 3/ | 5.9 ± 0.2 | 6 ± 0.1 | 6.1 ± 0.1 | 6 ± 0.3 |
| Silicone Additive | | | | |
| RATE OF | | | | |
| CONSUMPTION: | | | | |
| Wax 2 | 5 ± 0.43 | | | |
| Fragrance 3 | 4.4 ± 0.61 | | | |
| Fragrance 3/ | 5.1 ± 0.23 | | | |
| Silicone Additive | | | | |

### EXAMPLE 7

89.5 g of wax 2 was melted in a double boiler/water bath. 10 g of fragrance 5 and 0.5 g of a particular pendant aromatic and ethylene oxide modified polydimethylsiloxane additive was blended together in a conventional manner. This mixture was then added to the molten wax until homogenous, and prior to being poured into a glass mold fitted with a wick near the center of the mold to form a wax mixture. Separately 10 g of fragrance 5 was added to molten wax 2, and prior to being poured into a glass mold fitted with a wick near the center of the mold to form another wax mixture. The wax mixtures were allowed to cool under ambient conditions.

The wax mixtures were tested for combustion in the manner detailed in Example 4. The example reveals that the flame height, burn pool diameter, and rate of consumption are the same for all 3 wax mixtures tested and that the silicone additive did not affect combustion.

| | 1 hr. | 2 hr. | 3 hr. | 4 hr. |
|---|---|---|---|---|
| FLAME HEIGHT: | | | | |
| Wax 2 | 2.3 ± 0.2 | 2.9 ± 0.4 | 3.7 ± 0.4 | 4.1 ± 0.2 |
| Fragrance 5 | 2.8 ± 0.7 | 3.1 ± 0.9 | 3.8 ± 0.3 | 4.1 ± 0.5 |
| Fragrance 5/ | 3.4 ± 0.5 | 4 ± 0 | 3.8 ± 0.7 | 4.4 ± 1.0 |
| Silicone Additive | | | | |
| BURN POOL | | | | |
| DIAMETER: | | | | |
| Wax 2 | 4.6 ± 0.4 | 5 ± 0.3 | 5.5 ± 0.2 | 5.8 ± 0.2 |
| Fragrance 5 | 5.8 ± 0.1 | 5.9 ± 0.2 | 6.1 ± 0.1 | 6.1 ± 0.1 |
| Fragrance 5/ | 6.1 ± 0.1 | 6.1 ± 0.1 | 5.7 ± 0.5 | 6.1 ± 0.1 |
| Silicone Additive | | | | |
| RATE OF | | | | |
| CONSUMPTION: | | | | |
| Wax 2 | 4.98 ± 0.43 | | | |
| Fragrance 5 | 5.07 ± 0.50 | | | |
| Fragrance 5/ | 5.53 ± 0.37 | | | |
| Silicone Additive | | | | |

### EXAMPLE 8

Candles were once again prepared in the manner detailed in Example 4 and evaluated for candle bleed by wrapping them in preweighed absorbent tissue, and subjecting them to accelerated aging via temperature cycling over a 24 hr. period. The tissue was reweighed and the weight gain is considered to be a result of migrating fragrance. The example shows a reduction in weeping when the silicone additive of the present invention was present in the wax mixture.

SYNERESIS
SUBSTRATE WEIGHT GAIN IN GRAMS

| | |
|---|---|
| Fragrance 2 | 0.185 ± 0.00 g |
| Fragrance 2/Silicone Additive | 0.084 ± 0.02 g |

### EXAMPLE 9

Candles were once again prepared in the manner detailed in Example 5 and evaluated for candle bleed by wrapping them in preweighed

SYNERESIS
SUBSTRATE WEIGHT GAIN IN GRAMS

| | |
|---|---|
| Fragrance 3 | 2.057 ± 0.31 g |
| Fragrance 3/Silicone Additive | 1.0685 ± 0.10 g |

absorbent tissue, and subjecting them to accelerated aging via temperature cycling over a 24 hr. period. The tissue was reweighed and the weight gain is considered to be a result of migrating fragrance. The example shows a reduction in weeping when the silicone additive of the present invention was present in the wax mixture.

### EXAMPLE 10

Important performance attributes of wax mixtures and in particular candles is the intensity of the cold throw and hot throw. Cold throw is the impact of an organic compound and in particular a fragrance before combustion. Hot throw is the impact of the organic compound and in particular a fragrance during the combustion process. Wax mixtures were prepared in the manner previously detailed in Example 4 and assessed for cold and hot throw by removing a 0.5 g core sample of the wax mixture with a #2 cork borer and placing in a 20 ml head space vial and evaluating the head space by GC-MS under two different temperature conditions.

Results from this experiment indicate that the wax mixture containing the silicone additive had a stronger cold and hot throw than the wax mixture containing the same amount of the same fragrance.

PEAK AREA

| | Cold Throw | Hot Throw |
|---|---|---|
| Fragrance 2 | 9899205 | 6835241 |
| Fragrance 2/Silicone Additive | 10092581 | 9071971 |

### EXAMPLE 11

Wax mixtures were prepared in the manner described in Example 5 and assessed for cold and hot throw by removing a 0.5 g core sample of the wax mixture with a #2 cork borer and placing in a 20 ml head space vial and evaluating the head space by GC-MS under two different temperature conditions.

Results from this experiment indicate that the candle containing the silicone additive had a stronger hot throw than the wax mixture containing the same amount of the same fragrance.

PEAK AREA

| | Cold Throw | Hot Throw |
|---|---|---|
| Fragrance 3 | | 864922 |
| Fragrance 3/Silicone Additive | | 969900 |

### EXAMPLE 12

89.5 g of wax 2 was melted in a double boiler/water bath. 10 g of fragrance 6 and 0.5 g of a particular pendant propylene oxide modified polydimethylsiloxane additive was blended together in a conventional manner. This mixture was then added to the molten wax until homogenous, and prior to being poured into a glass mold fitted with a wick near the center of the mold to form a wax mixture. Separately 10 g of fragrance 6 was added to molten wax 2, and prior to being poured into a glass mold fitted with a wick near the center of the mold to form another wax mixture. These examples of wax mixtures were assayed for cold and hot throw in the manner previously described.

Results from this experiment indicate that the candle containing the silicone additive had stronger cold and hot throw than the wax mixture containing the same amount of the same fragrance.

PEAK AREA

| | Cold Throw | Hot Throw |
|---|---|---|
| Fragrance 6 | 313232 | 438512 |
| Fragrance 6/Silicone Additive | 2221604 | 2695897 |

### EXAMPLE 13

89.5 g of wax 2 was melted in a double boiler/water bath. 10 g of fragrance 5 and 0.5 g of a particular pendant aromatic and ethylene oxide modified polydimethylsiloxane additive was blended together in a conventional manner. This mixture was then added to the molten wax until homogenous, and prior to being poured into a glass mold fitted with a wick near the center of the mold to form a wax mixture. Separately 10 g of fragrance 5 was added to molten wax 2, and prior to being poured into a glass mold fitted with a wick near the center of the mold to form another wax mixture. These examples of wax mixtures were assayed for cold and hot throw in the manner previously described.

Results from this experiment indicate that the candle containing the silicone additive had stronger cold and hot throw than the wax mixture containing the same amount of the same fragrance.

PEAK AREA

| | Cold Throw | Hot Throw |
|---|---|---|
| Fragrance 5 | 64354 | 5817747 |
| Fragrance 5/Silicone Additive | 186200 | 15835226 |

Having described the invention, we claim:

1. A composition suitable for use in wax mixtures comprising:
a. a wax;
b. an organic compound; and
c. a compatibilizing agent whereby said compatibilizing agent does not extinguish the flame when the candle is burned.

2. A composition suitable for use in wax mixtures comprising:
a. a wax;
b. an organic compound; and
c. a compatibilizing agent.

3. A method for preventing phase separation in a candle comprising a wax and a fragrant compound, said method comprising:
a. admixing
i) a fragrant compound and
ii) a compatibiltizing agent to form a mixture and
b. adding the mixture to a wax forming a candle precursor
c. making a candle using the candle precursor.

4. The composition of claim 1 where the compatibilizing agent is a silicone having the formula:
MₐM_{b}M_{c}DₓD_{y}D_{z}T_{d}TₑT_{f}Q_{g};
where
Mₐ=R¹R²R³SiO_{1/2};[ICP14]
M_{b}=R⁴R⁵R⁶SiO_{1/2};[ICP15]
M_{c}=R⁷R⁸R⁹SiO_{1/2};[ICP16]
Dₓ=R¹⁰R¹¹SiO_{2/2}; [ICP17]
D_{y}=R¹²R¹³SiO_{2/2};[ICP18]
D_{z}=R¹⁴R¹⁵SiO_{2/2}[ICP19]
T_{d}=R¹⁶SiO_{3/2};[ICP20]
Tₑ=R¹⁷SiO_{3/2};[ICP21]
T_{f}=R¹⁸SiO_{3/2};[ICP22]
Q_{g}=SiO_{4/2}
where R¹, R², R³, R⁵, R⁶, R⁸, R⁹, R¹⁰, R¹¹, R¹³, R¹⁵ and R¹⁶ are each independently selected from the group consisting of one to sixty carbon monovalent hydrocarbon radicals, alkyl aryl radicals, aryl radicals, alkyl phenol radicals;
R⁴, R⁷, R¹², R¹⁴, R¹⁷ and R¹⁸ are each independently selected from the group radicals defined by the formula for Z; [ICP23] [ICP24]
where the subscripts a, b, c, x, y, z, d, e, f, and g are zero or positive integers for molecules subject to the following relationships:
(a+b+c) equals either (2+d+e+f+2g) or (d+e+f+2g) [ICP25]
0≦(x+y+z)≦100;
0≦(d+e+f)≦5;
0<g<3
with the requirement that b+y+e≧1;
and c+z+f>3, with Z having the formula:
BO(C₂H₄O)ₙ(C₃H₆O)ₚ(C₄H₈O)ᵣR¹⁸
where B is an alkylene radical of 2 to 4 carbons
R¹⁸ is a H, or a hydrocarbon radical of 1 to 4 carbons.
n, p and r are independently zero or positive subject to the requirement that:
4≦n+p+r≦100.

5. The composition of claim 2 where the compatibilizing agent is a silicone having the formula:
MₐM_{b}M_{c}DₓD_{y}D_{z}T_{d}TₑT_{f}Q_{g};
where
Mₐ=R¹R²R³SiO_{1/2};[ICP26]
M_{b}=R⁴R⁵R⁶SiO_{1/2};[ICP27]
M_{c}=R⁷R⁸R⁹SiO_{1/2};[ICP28]
Dₓ=R¹⁰R¹¹SiO_{2/2}; [ICP29]
D_{y}=R¹²R¹³SiO_{2/2};[ICP30]
D_{z}=R¹⁴R¹⁵SiO_{2/2}[ICP31]
T_{d}=R¹⁶SiO_{3/2};[ICP32]
Tₑ=R¹⁷SiO_{3/2};[ICP33]
T_{f}=R¹⁸SiO_{3/2};[ICP34]
Q_{g}=SiO_{4/2}
where R¹, R², R³, R⁵, R⁶, R⁸, R⁹, R¹⁰, R¹¹, R¹³, R¹⁵ and R¹⁶ are each independently selected from the group consisting of one to sixty carbon monovalent hydrocarbon radicals, alkyl aryl radicals, aryl radicals, alkyl phenol radicals;
R⁴, R⁷, R¹², R¹⁴, R¹⁷ and R¹⁸ are each independently selected from the group radicals defined by the formula for Z; [ICP35] [ICP36]
where the subscripts a, b, c, x, y, z, d, e, f, and g are zero or positive integers for molecules subject to the following relationships:
(a+b+c) equals either (2+d+e+f+2g) or (d+e+f+2g) [ICP37]
0≦(x+y+z)≦100;
0≦(d+e+f)≦5;
0<g<3
with the requirement that b+y+e≧1;
and c+z+f>3, with Z having the formula:
BO(C₂H₄O)ₙ(C₃H₆O)ₚ(C₄H₈O)ᵣR¹⁸
where B is an alkylene radical of 2 to 4 carbons
R¹⁸ is a H, or a hydrocarbon radical of 1 to 4 carbons.
n, p and r are independently zero or positive subject to the requirement that:
4≦n+p+r≦100.

6. The composition of claim 1 wherein the organic compound is a fragrant compound.

7. The composition of claim 2 wherein the organic compound is a fragrant compound.

8. The composition of claim 6 wherein the fragrant compound is selected from the group consisting of anethole, cinnamaldehyde, eugenol, benzyl benzoate, benzyl benzoate, benzyl salicylate, diphenyl oxide, benzyl acetate, α-amyl cinnamaldehyde, α-hexyl cinnamaldehyde, heliotropin, cyclamen aldehyde, p-t-butyl-α-methyl dihydrocinnamaldehyde, raspberry ketone, 2-phenylethyl alcohol and esters thereof, benzaldehyde, Coumarin, Isoamyl salicylate, Ethyl vanillin, Vanillin, methyl salicylate, moskene, isochroman musk, msk xylol, musk tibetine, musk ambrette, musk ketone, muscone, 5-acetyl-1,1,2,3,3,6-hexamethylindan, 5-acetyl-1,1,2,6-tetramethyl-3-isopropylindan, tetralin musk, civetone, cyclopentadecanolide, cyclopentadecanone, indan musk 4-acetyl-1,1-dimethyl-6-t-butyl-indan, thylene brassylate, fixateur 404, benzyl alcohol, vernaldehyde, leaf alcohol,
maltol, ethyl maltol, verdyl acetate, jasmone, isojasmone, dihydrojasmone, Sandela, Vernetex, 4-(4-hydroxy-4-methylpentyl)-3-cyclohexene-10-carboxaldehyde, aliphatic aldehydes, fatty esters, Indoles, pyrazines, thiazoles, α-terpinol and esters thereof, citronellal and esters thereof, citronellol and esters thereof, linalool and esters thereof, citral, neral, hydroxycitronellal, geraniol and esters thereof, nerol and esters thereof, tetrahydrogeraniol, dimethyl octanol, ionones, borneol, borneol acetate, isoborneol, isoborneol acetate, acetylated cedarwood, 1-carvone, and 1-menthol.

9. The composition of claim 7 wherein the fragrant compound is selected from the group consisting of anethole, cinnamaldehyde, eugenol, benzyl benzoate, benzyl benzoate, benzyl salicylate, diphenyl oxide, benzyl acetate, α-amyl cinnamaldehyde, α-hexyl cinnamaldehyde, heliotropin, cyclamen aldehyde, p-t-butyl-α-methyl dihydrocinnamaldehyde, raspberry ketone, 2-phenylethyl alcohol and esters thereof, benzaldehyde, Coumarin, Isoamyl salicylate, Ethyl vanillin, Vanillin, methyl salicylate, moskene, isochroman musk, msk xylol, musk tibetine, musk ambrette, musk ketone, muscone, 5-acetyl-1,1,2,3,3,6-hexamethylindan, 5-acetyl-1,1,2,6-tetramethyl-3-isopropylindan, tetralin musk, civetone, cyclopentadecanolide, cyclopentadecanone, indan musk 4-acetyl-1,1-dimethyl-6-t-butyl-indan, thylene brassylate, fixateur 404, benzyl alcohol, vernaldehyde, leaf alcohol, maltol, ethyl maltol, verdyl acetate, jasmone, isojasmone, dihydrojasmone, Sandela, Vernetex, 4-(4-hydroxy-4-methylpentyl)-3-cyclohexene-10-carboxaldehyde, aliphatic aldehydes, fatty esters, Indoles, pyrazines, thiazoles, α-terpinol and esters thereof, citronellal and esters thereof, citronellol and esters thereof, linalool and esters thereof, citral, neral, hydroxycitronellal, geraniol and esters thereof, nerol and esters thereof, tetrahydrogeraniol, dimethyl octanol, ionones, borneol, borneol acetate, isoborneol, isoborneol acetate, acetylated cedarwood, 1-carvone, and 1-menthol.

10. The composition of claim 1 where the compatibilizing agent is a silicone having the formula:
(A¹B¹)ₜ
where A¹ has the general structure:
—Si(R¹⁹)(R²⁰)O—(Si(R²¹)(R²²)O—)ₓ—Si(R²³)(R²⁴)—
and B¹ has the general structure:
—R²⁵OR²⁶R²⁷—
where R¹⁹, R²⁰, R²¹, R²², R²³ and R²⁴ are independently selected from a monovalent hydrocarbon radical of 1 to 4 carbons; t is 2 to 1000; x is 0 to 50; R²⁵ and R²⁷ are independently selected from a divalent hydrocarbon radical of 2 to 10 carbons or Y¹; Y¹ is a monovalent hydrocarbon radical of 1 to 6 carbons, each optionally OH substituted, or R²⁸, where R²⁸ is CH₂═CH(R²⁹)(R³⁰)_{g}—; R²⁹ is H or methyl; R³⁰ is selected from a divalent hydrocarbon radical of 1 to 7 carbons; g is 0 or 1, and
R²⁶ is selected from a group of polyalkyleneoxide radicals of the structure:
—(C₂H₄O)_{d}(C₃H₆O)ₑ(C₄H₈O)_{f}—, where subscripts d+e+f are zero or positive and satisfy the following relationships: 2≦d+e+f≦100.

11. The composition of claim 2 where the compatibilizing agent is a silicone having the formula:
(A¹B¹)ₜ
where A¹ has the general structure:
—Si(R¹⁹)(R²⁰)O—(Si(R²¹)(R²²)O—)ₓ—Si(R²³)(R²⁴)—
and B¹ has the general structure:
—R²⁵OR²⁶R²⁷—
where R¹⁹, R²⁰, R²¹, R²², R²³ and R²⁴ are independently selected from a monovalent hydrocarbon radical of 1 to 4 carbons; t is 2 to 1000; x is 0 to 50; R²⁵ and R²⁷ are independently selected from a divalent hydrocarbon radical of 2 to 10 carbons or Y¹; Y₁ is a monovalent hydrocarbon radical of 1 to 6 carbons, each optionally OH substituted, or R²⁸, where R²⁸ is CH₂═CH(R²⁹)(R³⁰)_{g}—; R²⁹ is H or methyl; R³⁰ is selected from a divalent hydrocarbon radical of 1 to 7 carbons; g is 0 or 1, and
R²⁶ is selected from a group of polyalkyleneoxide radicals of the structure:
—(C₂H₄O)_{d}(C₃H₆O)ₑ(C₄H₈O)_{f}—, where subscripts d+e+f are zero or positive and satisfy the following relationships: 2≦d+e+f≦100.

12. The composition of claim 10 wherein the organic compound is a fragrant compound.

13. The composition of claim 11 wherein the organic compound is a fragrant compound.

14. The composition of claim 12 wherein the fragrant compound is selected from the group consisting of anethole, cinnamaldehyde, eugenol, benzyl benzoate, benzyl benzoate, benzyl salicylate, diphenyl oxide, benzyl acetate, α-amyl cinnamaldehyde, α-hexyl cinnamaldehyde, heliotropin, cyclamen aldehyde, p-t-butyl-α-methyl dihydrocinnamaldehyde, raspberry ketone, 2-phenylethyl alcohol and esters thereof, benzaldehyde, Coumarin, Isoamyl salicylate, Ethyl vanillin, Vanillin, methyl salicylate, moskene, isochroman musk, msk xylol, musk tibetine, musk ambrette, musk ketone, muscone, 5-acetyl-1,1,2,3,3,6-hexamethylindan, 5-acetyl-1,1,2,6-tetramethyl-3-isopropylindan, tetralin musk, civetone, cyclopentadecanolide, cyclopentadecanone, indan musk 4-acetyl-1,1-dimethyl-6-t-butyl-indan, thylene brassylate, fixateur 404, benzyl alcohol, vernaldehyde, leaf alcohol, maltol, ethyl maltol, verdyl acetate, jasmone, isojasmone, dihydrojasmone, sandela, vernetex, 4-(4-hydroxy-4-methylpentyl)-3-cyclohexene-10-carboxaldehyde, aliphatic aldehydes, fatty esters, Indoles, pyrazines, thiazoles, α-terpinol and esters thereof, citronellal and esters thereof, citronellol and esters thereof, linalool and esters thereof, citral, neral, hydroxycitronellal, geraniol and esters thereof, nerol and esters thereof, tetrahydrogeraniol, dimethyl octanol, ionones, borneol, borneol acetate, isoborneol, isoborneol acetate, acetylated cedarwood, 1-carvone, and 1-menthol.

15. The composition of claim 13 wherein the fragrant compound is selected from the group consisting of anethole, cinnamaldehyde, eugenol, benzyl benzoate, benzyl benzoate, benzyl salicylate, diphenyl oxide, benzyl acetate, α-amyl cinnamaldehyde, α-hexyl cinnamaldehyde, heliotropin, cyclamen aldehyde, p-t-butyl-α-methyl dihydrocinnamaldehyde, raspberry ketone, 2-phenylethyl alcohol and esters thereof, benzaldehyde, Coumarin, Isoamyl salicylate, Ethyl vanillin, Vanillin, methyl salicylate, moskene, isochroman musk, msk xylol, musk tibetine, musk ambrette, musk ketone, muscone, 5-acetyl-1,1,2,3,3,6-hexamethylindan, 5-acetyl-1,1,2,6-tetramethyl-3-isopropylindan, tetralin musk, civetone, cyclopentadecanolide, cyclopentadecanone, indan musk 4-acetyl-1,1-dimethyl-6-t-butyl-indan, thylene brassylate, fixateur 404, benzyl alcohol, vernaldehyde, leaf alcohol, maltol, ethyl maltol, verdyl acetate, jasmone, isojasmone, dihydrojasmone, sandela, vernetex, 4-(4-hydroxy-4-methylpentyl)-3-cyclohexene-10-carboxaldehyde, aliphatic aldehydes, fatty esters, Indoles, pyrazines, thiazoles, c-terpinol and esters thereof, citronellal and esters thereof, citronellol and esters thereof, linalool and esters thereof, citral, neral, hydroxycitronellal, geraniol and esters thereof, nerol and esters thereof, tetrahydrogeraniol, dimethyl octanol, ionones, borneol, borneol acetate, isoborneol, isoborneol acetate, acetylated cedarwood, 1-carvone, and 1-menthol.

16. The composition of claim 1 where the compatibilizing agent is a silicone having the formula:
(A²B²C¹)ₘ
where A² has the general structure:
—(R³¹—Si(R³⁵)(R³⁶)O—(Si(R³⁷)(R³⁸)O)ᵥ—Si(R³⁹)(R⁴⁰)—R³²)—
B² is an amine-connecting group with the general formula:
—N(R⁴¹)(R⁵⁴)Ψ—
C¹ is a polyalkyleneoxide moiety of the general structure:
—R⁴²—O—R⁴³—R⁴⁴—
where R³⁵, R³⁶, R³⁷, R³⁸, R³⁹ and R⁴⁰ are independently selected from a monovalent hydrocarbon radical of 1 to 4 carbons; m is 2 to 1000; v is 0 to 50; R³¹ and R³² are independently selected from a divalent hydrocarbon radical of 2 to 10 carbons, which are optionally OH substituted, or R³³; R³³ is an epoxy group of the general formula:
—R⁵⁰(O)_{L}(R⁵¹)_{I}R⁵²
where R⁵⁰ and R⁵¹ are independently selected from a divalent hydrocarbon radical of 1 to 10 carbons; R⁵² is —CH(O)CH₂, or a cyclohexeneoxide of the formula —C₆(R⁵³)ᵤH₉₋ᵤO; R⁵³ is a monovalent hydrocarbon group of 1 to 2 carbon atoms; R⁵⁴ is hydrogen, a monovalent hydrocarbon radical of 1 to 4 carbons, and a hydrocarbon radical containing an OH group; subscripts L and I are 0 or 1; u is 0 to 2; T is 0 or 1.

17. The composition of claim 2 where the compatibilizing agent is a silicone having the formula:
(A²B²C¹)ₘ
where A² has the general structure:
—(R³¹—Si(R³⁵)(R³⁶)O—(Si(R³⁷)(R³⁸)O)ᵥ—Si(R³⁹)(R⁴⁰)—R³²)—
B² is an amine-connecting group with the general formula:
—N(R⁴¹)(R⁵⁴)_{Ψ}—
C¹ is a polyalkyleneoxide moiety of the general structure:
—R⁴²—O—R⁴³—R⁴⁴—
where R³⁵, R³⁶, R³⁷, R³⁸, R³⁹ and R⁴⁰ are independently selected from a monovalent hydrocarbon radical of 1 to 4 carbons; m is 2 to 1000; v is 0 to 50; R³¹ and R³² are independently selected from a divalent hydrocarbon radical of 2 to 10 carbons, which are optionally OH substituted, or R³³; R³³ is an epoxy group of the general formula:
—R⁵⁰(O)_{L}(R⁵¹)_{I}R⁵²
where R⁵⁰ and R⁵¹ are independently selected from a divalent hydrocarbon radical of 1 to 10 carbons; R⁵² is —CH(O)CH₂, or a cyclohexeneoxide of the formula —C₆(R⁵³)ᵤH₉₋ᵤO; R⁵³ is a monovalent hydrocarbon group of 1 to 2 carbon atoms; R⁵⁴ is hydrogen, a monovalent hydrocarbon radical of 1 to 4 carbons, and a hydrocarbon radical containing an OH group; subscripts L and I are 0 or 1; u is 0 to 2; T is 0 or 1.

18. The composition of claim 16 wherein the organic compound is a fragrant compound.

19. The composition of claim 17 wherein the organic compound is a fragrant compound.

20. The composition of claim 18 wherein the fragrant compound is selected from the group consisting of anethole, cinnamaldehyde, eugenol, benzyl benzoate, benzyl benzoate, benzyl salicylate, diphenyl oxide, benzyl acetate, α-amyl cinnamaldehyde, α-hexyl cinnamaldehyde, heliotropin, cyclamen aldehyde, p-t-butyl-α-methyl dihydrocinnamaldehyde, raspberry ketone, 2-phenylethyl alcohol and esters thereof, benzaldehyde, Coumarin, Isoamyl salicylate, Ethyl vanillin, Vanillin, methyl salicylate, moskene, isochroman musk, msk xylol, musk tibetine, musk ambrette, musk ketone, muscone, 5-acetyl-1,1,2,3,3,6-hexamethylindan, 5-acetyl-1,1,2,6-tetramethyl-3-isopropylindan, tetralin musk, civetone, cyclopentadecanolide, cyclopentadecanone, indan musk 4-acetyl-1,1-dimethyl-6-t-butyl-indan, thylene brassylate, fixateur 404, benzyl alcohol, vernaldehyde, leaf alcohol, maltol, ethyl maltol, verdyl acetate, jasmone, isojasmone, dihydrojasmone, sandela, vernetex, 4-(4-hydroxy-4-methylpentyl)-3-cyclohexene-10-carboxaldehyde, aliphatic aldehydes, fatty esters, Indoles, pyrazines, thiazoles, α-terpinol and esters thereof, citronellal and esters thereof, citronellol and esters thereof, linalool and esters thereof, citral, neral, hydroxycitronellal, geraniol and esters thereof, nerol and esters thereof, tetrahydrogeraniol, dimethyl octanol, ionones, borneol, borneol acetate, isoborneol, isoborneol acetate, acetylated cedarwood, 1-carvone, and 1-menthol.

21. The composition of claim 19 wherein the fragrant compound is selected from the group consisting of anethole, cinnamaldehyde, eugenol, benzyl benzoate, benzyl benzoate, benzyl salicylate, diphenyl oxide, benzyl acetate, α-amyl cinnamaldehyde, α-hexyl cinnamaldehyde, heliotropin, cyclamen aldehyde, p-t-butyl-α-methyl dihydrocinnamaldehyde, raspberry ketone, 2-phenylethyl alcohol and esters thereof, benzaldehyde, Coumarin, Isoamyl salicylate, Ethyl vanillin, Vanillin, methyl salicylate, moskene, isochroman musk, msk xylol, musk tibetine, musk ambrette, musk ketone, muscone, 5-acetyl-1,1,2,3,3,6-hexamethylindan, 5-acetyl-1,1,2,6-tetramethyl-3-isopropylindan, tetralin musk, civetone, cyclopentadecanolide, cyclopentadecanone, indan musk 4-acetyl-1,1-dimethyl-6-t-butyl-indan, thylene brassylate, fixateur 404, benzyl alcohol, vernaldehyde, leaf alcohol, maltol, ethyl maltol, verdyl acetate, jasmone, isojasmone, dihydrojasmone, sandela, vernetex, 4-(4-hydroxy-4-methylpentyl)-3-cyclohexene-10-carboxaldehyde, aliphatic aldehydes, fatty esters, Indoles, pyrazines, thiazoles, α-terpinol and esters thereof, citronellal and esters thereof, citronellol and esters thereof, linalool and esters thereof, citral, neral, hydroxycitronellal, geraniol and esters thereof, nerol and esters thereof, tetrahydrogeraniol, dimethyl octanol, ionones, borneol, borneol acetate, isoborneol, isoborneol acetate, acetylated cedarwood, 1-carvone, and 1-menthol.
